(19) United States
(12) Patent Application Publication
(10) Pub. No.: US 2012/0301201 A1
(43) Pub. Date: Nov. 29, 2012

(54) Manual Keyboard

(75) Inventor: Jack ATZMON, Englewood, NJ (US)

(73) Assignee: Smartfish Technologies, Englewood, NJ (US)

(21) Appl. No.: 13/480,258

(22) Filed: May 24, 2012

Related U.S. Application Data
(60) Provisional application No. 61/489,552, filed on May 24, 2011.

(51) Int. Cl. B41J 5/26

(52) U.S. Cl. 400/481

(57) ABSTRACT

A keyboard includes an indicator and a drive mechanism. The drive mechanism is configured to drive each of a plurality of keyboard zones to move in a synchronous sequence. The drive mechanism simultaneously tilts and abducts each of the plural keyboard zones. The indicator mechanism guides the user when movement should be initiated and when a new use position is reached that is based on the user's needs.

### RELATED APPLICATIONS

This application claims priority from U.S. Provisional Patent Application Ser. No. 61/489,552 which was filed on May 24, 2011.

### BACKGROUND OF THE INVENTION

1. Field of the Invention

The present invention relates to keyboards, and more particularly to a manually adjusting ergonomic keyboard.

2. Description of the Related Art

A known ergonomic keyboard is split and manually moveable in a tenting motion. This keyboard is not motorized or provided with sensors. It offers no way to guide the user to the best keyboard positions. A manual adjustment mechanism is used so for the user can decide on the best course of treatment. There is no adaptation at all to address repetition a key component to carpal tunnel syndrome and repetitive stress injuries. This type of device still limits needed variation in position and other adaptations for the user that could alleviate or avoid injury. This device also lacks user guidance to optimal positioning and limits adaptation to user only initiated positioning.

Another known ergonomic keyboard does not alter its position at all. There is no attention or adaptation for different sized users, different injuries, or environments. This keyboard fails to address most of the needs of carpal tunnel and repetitive stress injury sufferers. In fact, it does nothing to address the chief cause of carpal tunnel and repetition strain injury, repetition itself.

Another known keyboard has sections that move or pivot in response to use. The sections are all substantially on an underlying surface of the keyboard that elevates towards the middle and towards the outer edges, and descends towards the front. Legs attach the keyboard sections to underlying gears. Multiple gears, and multiple motors, if necessary, allow the sections of the keyboard to move either as a group or individually to each area of the underlying surface.

### SUMMARY OF THE INVENTION

While the foregoing described prior art devices have provided improvement over fixed inflexible work station environments or ordinary flat keyboards, there remains a continuing need in the art for work station environments and apparatuses that provide further attention to the physical needs of the user and which protect the user more substantially against the limited motion and confined motion types of injuries such as carpal tunnel syndrome or repetitive motion syndrome. The movements are not merely cyclical or periodic but responsive to a user's needs.

An object of the present invention is to provide a keyboard that alters its shape under user control in response to a signal informing the user that the keyboard should be adjusted. In particular, the present keyboard includes a manual drive mechanism that, among other motions, causes keyboard sections to one or more of abduct, pivot, splay, or the like. Alternatively, an user activated drive performs these movements.

In one embodiment of the invention, a drive mechanism is provided that allows each of a plurality of keyboard zones to move in a synchronous sequence. The drive mechanism, which is user activated, one or more of simultaneously tilts, splays, rocks, and abducts each of the plural keyboard zones. In a preferred embodiment, the user is signaled when to begin adjusting the keyboard and when to stop adjusting the keyboard. In one embodiment, the user manually controls a motor that adjusts the keyboard.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention are specified below accompanied by descriptions of exemplary embodiments and with reference to the figures in the drawing. In said drawing:

FIG. 1 is a top view of a keyboard according to an embodiment of the invention in a first position;

FIG. 2 is a top view of a keyboard according to an embodiment of the invention in a second position;

FIG. 3 is a side view of a keyboard according to an embodiment of the invention in a first position;

FIG. 4 is a side view of a keyboard according to an embodiment of the invention in a second position; and

FIG. 5 is a top view of a keyboard drive mechanism according to an embodiment of the invention.

### DETAILED DESCRIPTION OF THE PRESENTLY PREFERRED EMBODIMENTS

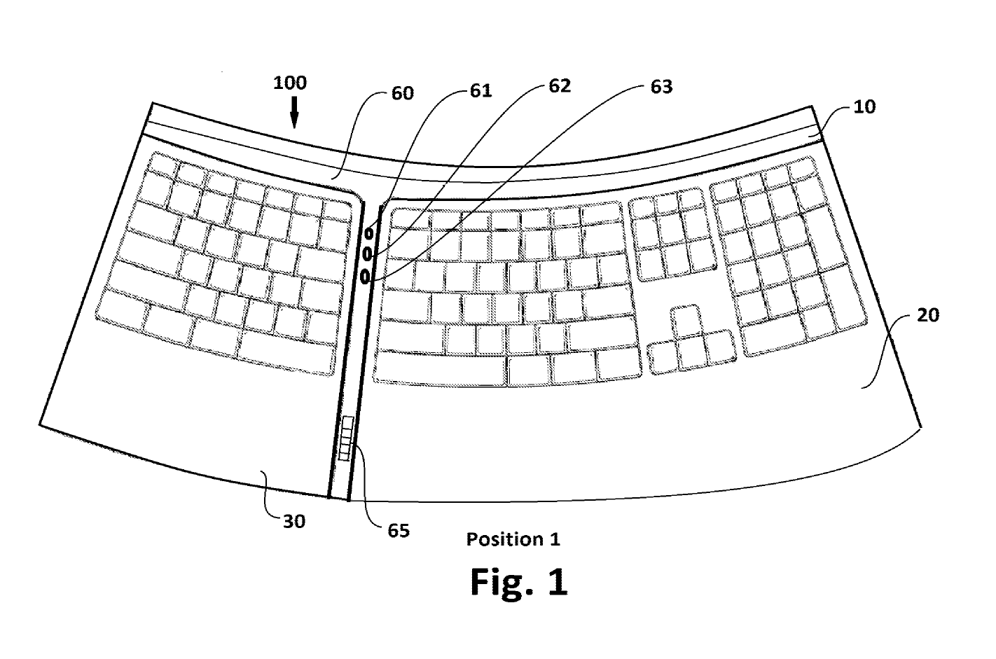

FIG. 1 is a top view of a keyboard 100 according to an embodiment of the invention in a first position. As shown, the keyboard has two moveable key sections 20 and 30 in a frame 10. While two keyboard sections are shown, the keyboard can be divided into any number of sections. In one embodiment of the invention, the number pad is a separate section of the keyboard that is configured for independent movement. In one embodiment of the invention, the portions of the key sections 20 and 30 adjacent to frame section 60 are raised with respect to the portions of key sections 20 and 30 distally located from frame section 60. In a preferred embodiment, each key section is a smooth curve or arc. In another embodiment, a slide is provided that moves the keyboard sections.

In one embodiment, frame 60 includes indicators 61, 62, and 63. Preferably, the indicators are LEDs. In a preferred embodiment, the LEDs indicate when a user is to adjust the keyboard. The LEDs are configured such that LEDs 61 and 63 turn yellow and LED 62 turns green when the appropriate adjustment position is reached. Other color schemes or additional LEDs, or other indicators, can also be used to guide the user to adjust the keyboard. In one embodiment, tones, voice, or haptic feedback are used to indicate when motion should be initiated and/or stopped.

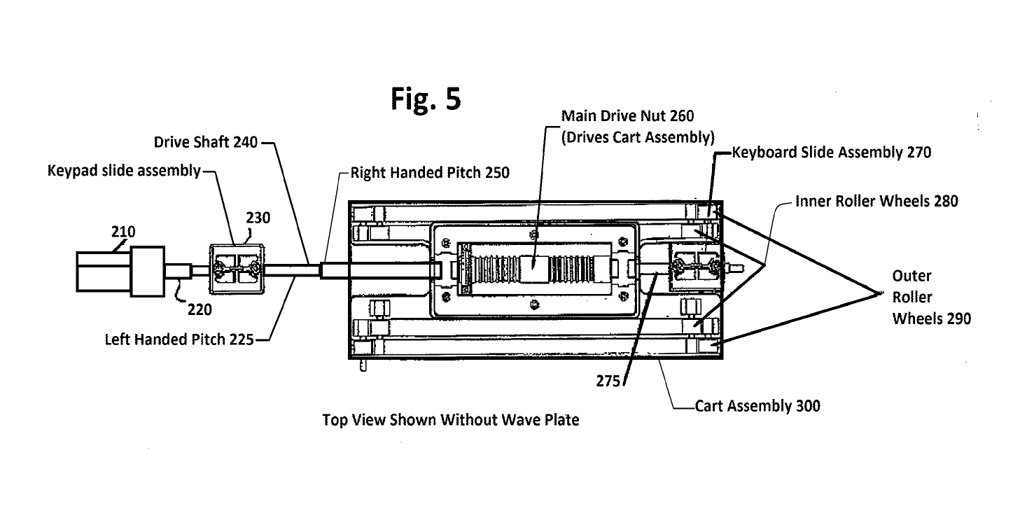

In one embodiment, the keyboard has a thumbwheel 65. Thumbwheel 65 is turned to adjust the position of the keyboard. In one embodiment, the thumbwheel drives the drive mechanism shown in FIG. 5. In another embodiment, 65 is a switch that activates a motor 210 to adjust the keyboard. Alternatively, a lever slides along an longitudinal edge of the keyboard to adjust the keyboard position. The user is instructed via the indicators when to initiate movement, what direction the movement should be, and when the newly reached position is reached.

The new position is responsive to the user's needs, not merely a next position. The position responsive to the user's needs is determined by a microprocessor coupled to the keyboard. The microprocessor is one of on the keyboard, in the computer or device to which the keyboard is connected, or at a server configured to control the keyboard.

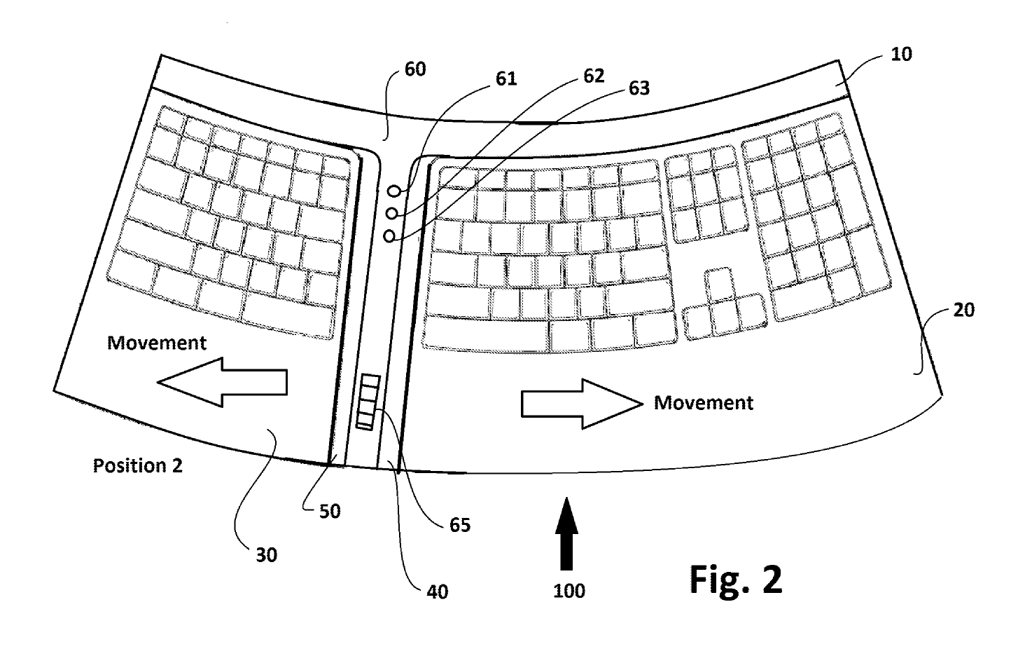

FIG. 2 is a top view of keyboard 100 after moveable key sections 20 and 30 abduct. As shown, each keyboard section 20, 30 moves a distance 40, 50 from central frame segment 60. In one embodiment, the key sections 20 and 30 are substantially in contact with one another without a central frame section 60. In FIG. 2, arrows designate the direction of abduction. It should be noted that key sections 20 and 30 move in a substantially linear manner.

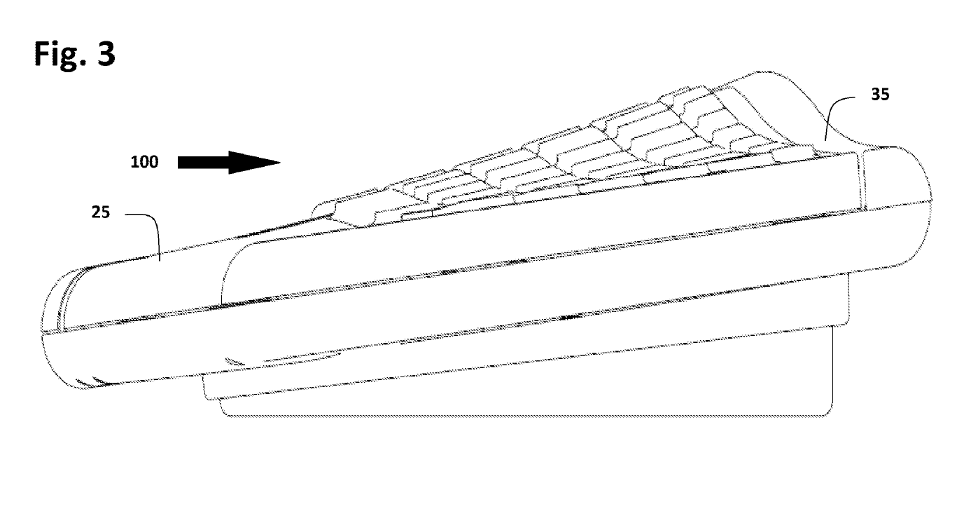

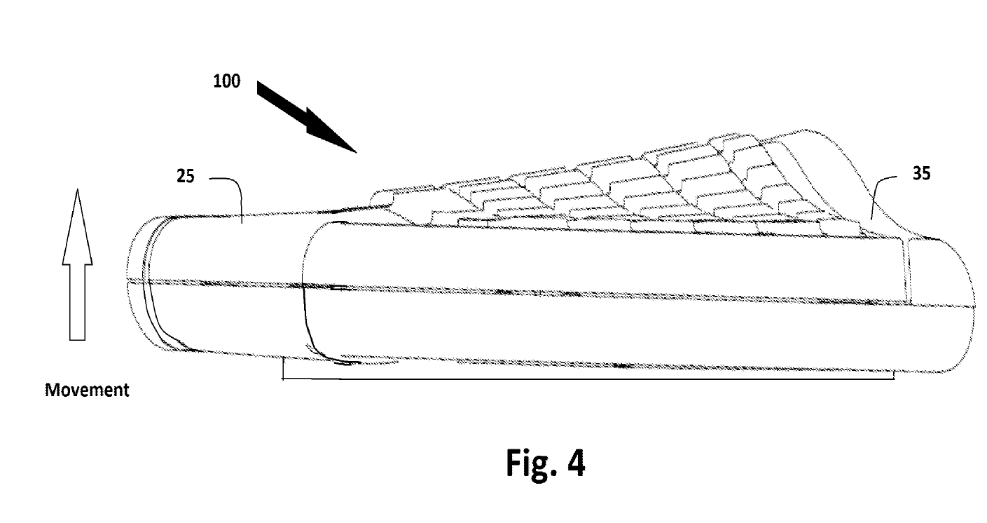

FIGS. 3 and 4 are a side view of the keyboard. FIGS. 3 and 4 depict a pivoting motion of the keyboard 100. As shown, a front edge 25 and a rear edge of the keyboard 35 are configured to seesaw about an axis that is substantially at a midline of the keyboard. In another embodiment, the axis about which the keyboard pivots is located offset from the midline of the keyboard.

FIG. 5 is a top view of a drive mechanism for the keyboard 100. In one embodiment, the drive mechanism comprises a drive motor 210. The motor 210 is powered via a USB connection, a transformer, batteries, or the like.

The motor is shown as a rotary motor. In another embodiment, a linear motor is used. Alternatively, the motor is merely thumbwheel 65. The motor is coupled to a drive shaft via coupler 220. In one embodiment, the coupler 220 is a variable clutch. A first drive shaft 240

is coupled to coupler 220. In a preferred embodiment, the first drive shaft 240 has a left-handed pitch 235.

In one embodiment, a keypad slide assembly 230 rides on the drive shaft. The slide assembly 230 has a coupling nut that rides on the threaded drive shaft so that as the drive shaft rotates, the slide assembly 230 moves laterally along the axis of the drive shaft. Variations in pitch and drive shaft diameter vary the speed of motion.

The drive shaft includes a portion 250 having a righthanded pitch. In one embodiment, the slide assembly moves the keypad and other auxiliary keys and a first keyboard slide assembly (not shown) is mounted on the drive shaft portion 250. A main drive unit 260 is configured to drive the cart assembly. A keyboard slide assembly 270 is mounted on the drive shaft portion 275. As the drive shaft is driven, the keyboard slide assembly 270 is laterally driven along the drive shaft. In a preferred embodiment, the two keyboard slide assemblies are driven in opposite directions due to the opposite thread pitch of their respective drive shaft portions.

Main drive unit 260 drives a cart assembly 300. Inner roller wheels and outer roller wheels are mounted to the cart assembly 300. The roller wheels serve to pivot the keyboard sections as discussed in more detail below. It should be noted that while the motor 210 is shown on one side of the assembly, in other embodiments, a plurality of motors are used. In another embodiment, the motor 210 is oriented at a middle of the assembly and the drive shafts extend laterally in both directions from the center position.

The keyboard is preferably microprocessor controlled. The control can be performed via a PC or an on-board microprocessor. In one embodiment, a computer program running on the user's computer controls when the user should initiate motion. In another embodiment, the program is stored on firmware, onboard the keyboard. In yet another embodiment, the program is stored in flash or other memory that can be updated. Control can also be transmitted from the keyboard or computer using wireless technology. In yet another embodiment, a server on a network such as a local LAN or the Internet controls the keyboard.

The keyboard's movement is controlled in one of several manners. The keyboard is configured to signal the user to initiate a position change based on user need, time, amount of use, distance moved temperature, heat, pulse rate, weight, or random motion. Additionally, a combination of factors will be used to determine when the user should initiate movement. Regular rhythmic patterns may also be used to move various portions of the keyboard. Movement may also be based on the program being used or expected keyboard motions. For example, the keyboard can be alerted that a program with heavy side-to-side movement is being used and so that movement may occur more often or with a different pattern.

The length of time the keyboard remains in any given position will be based at least in part on the above factors.

In one embodiment, the keyboard has a display window (not shown). In one embodiment, the display window is an LCD display. The display can include such items as the specific user, speed setting, motion type, and the like.

In one embodiment of the invention, a user is prompted to use an exercise program based in part on the user's activity. The program will prompt the user to perform tasks to minimize the risk of RSI.

Control software preferably includes, but is not be limited to, programming aimed at relieving or preventing a specific disease such as carpal tunnel or other ailments due to repetitive motion. The gradual movements of the plural keyboard sections substantially eliminate repetitive motion from the same angle thereby improving blood flow, changing position of the median nerve, and resting overworked muscles. The control software preferably stores user information so that a specific user can have a designated motion profile. The control software preferably provides periodic but imperceptible repositioning of the hands and wrists. The reposition provides movement is three axes.

The software programming will preferably monitor repetitive motion on specific keys and adjust the plural keyboard sections accordingly. If a user is constantly focusing on one or a few keys, then the programming will preferably indicate the need to adjust that portion accordingly, moving it more frequently, or various other angles.

The software can be stored on the keyboard itself, the computer or network to which it is attached, a third party computer or a server on the network, a dedicated hardware controller, or on an external source such as a key card or a USB memory card, solid state memory or other storage mechanisms.

In one embodiment, the customization of the software is manipulated by use of pre-programming, settings stored on the computer, server, or by user input. The configuration changes can be made automatically when the user logs on the computer or network. It can also be automatically configured with the help of biometrics or their personal key cards or identification cards. Once the user is identified, the software, wherever it is stored, can adjust the keyboard for that specific user.

In one embodiment, the user can set the keyboard to a preferred position. The keyboard does not vary from that position or, alternatively, the user preset is the starting point for motion.

In another embodiment, at least one of the keyboard and a wrist pad coupled to the keyboard could monitor hand and wrist rest temperature and in addition to the other mentioned adaptations to alleviate common hand and wrist and arm ailments. To that end, at least one of the keyboard and the wrist pad can be heated to warm a user's hands.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A keyboard comprising:
a plurality of keyboard sections, each of the plural keyboard sections having a plurality of keys;
a drive mechanism coupled to the plural keyboard sections; and
an indicator mechanism configured to
inform a user to activate the drive mechanism coupled to each of the plural keyboard sections and move the plural keyboard sections and
indicate when the keyboard has reached a new use position.

2. The keyboard of claim 1, wherein the drive mechanism is activated in response to a user's needs.

3. The keyboard of claim 1, wherein the drive mechanism comprises a thumbwheel.

4. The keyboard of claim 1, wherein the drive mechanism comprises a motor and a switch configures to activate a motor.
